(19) United States
(12) Patent Application Publication
(10) Pub. No.: US 2012/0246963 A1
(43) Pub. Date: Oct. 4, 2012

(54) DRYING APPARATUS

(75) Inventor: David Boyd Fisher, Crystal Lake, IL (US)

(73) Assignee: World Dryer Corporation, Berkeley, IL (US)

(21) Appl. No.: 13/079,370

(22) Filed: Apr. 4, 2011

(51) Int. Cl. F26B 21/06; F15D 1/00

(52) U.S. Cl. 34/241; 137/597; 137/343

(57) ABSTRACT

An apparatus such as a hand dryer is configured to expel air in the form of a heated flowstream and an unheated flowstream. The heated flowstream results from active heating, such as would occur when the apparatus exposes the air to a heating element. The heating element heats the air to a temperature that is greater than the air in the unheated flowstream. The apparatus can direct each of the heated flowstream and the unheated flowstream to an exit plane, which defines a first side on which the apparatus prevents the heated flowstream from mixing with the unheated flowstream. The exit plane also defines a second side on which a target can reside. The heated flowstream can mix with the unheated flowstream on the second side, wherein mixing can occur when the heated flowstream and the unheated flowstream impinge on the target.

### BACKGROUND

1. Technical Field

The subject matter disclosed herein relates generally to a drying apparatus and, more particularly, to one embodiment of a drying apparatus that expels air in a heated flowstream and an unheated flowstream.

2. Description of Related Art

Public and commercial washrooms deploy hand dryers for use in lieu of drying implements such as paper towels. The hand dryers generate a flow of air that removes materials (e.g., water) from a target (e.g., hands or face). In many cases, the hand dryers heat the air. The heated air, in combination with the flow kinetics (e.g., the flow rate) and fluid dynamics the hand dryer induces, is effective to expedite evaporative drying of the target that is positioned in the resulting flowstream. Nominally, the drying process for conventional hand dryers takes about 45 seconds.

Other hand dryers increase the flow rate to shorten the drying process to about 10-15 seconds. These “high-flow” hand dryers may still heat the air that the hand dryer expels onto the target. However, the heated air generally contributes less to the drying process because the heated air contacts the target for less time than occurs in hand dryers that expel air at lower flow rates. These hand dryers provide the heated air to cause the sensation of warmth, which helps to offset the sensation of cold (or cooling) that results from the evaporative drying process in high-flow hand dryers.

Hand dryers incorporate heating elements and air moving devices to generate and expel the heated air. Exemplary heating elements may consume anywhere from 900 W to 2300 W of input power, which is in addition to the input power the air moving device requires for operation. In one example, the ratio of the input power to energize the heating element to the input power to energize the air moving device can range from about 1.5:1 to about 2:1.

### SUMMARY

Reducing energy use is important to hand dryers and related devices. The discussion below highlights embodiments of a drying apparatus that require less power but that do not sacrifice performance or, in one implementation, comfort for the end user. Rather than expelling air at a uniform temperature, the inventors propose a drying apparatus that generates a number of flowstreams with different temperatures, such as a heated flowstream and an unheated flowstream. These flowstreams are, however, sufficient to maintain drying performance and to offer the sensation of warmth for the end user, while at the same time requiring less input power.

Broadly stated, the apparatus of the present disclosure expels air in the form of a heated flowstream and an unheated flowstream. The heated flowstream results from active heating, such as would occur when the apparatus exposes the air to a heating element. The heating element heats the air to a temperature that is greater than the air in the unheated flowstream. The apparatus can direct each of the heated flowstream and the unheated flowstream to an exit plane, which defines a first side on which the apparatus prevents the heated flowstream from mixing with the unheated flowstream. The exit plane also defines a second side on which a target can reside. The heated flowstream can mix with the unheated flowstream on the second side, wherein mixing can occur when the heated flowstream and the unheated flowstream impinge on the target.

In one embodiment, an apparatus is disclosed, comprising a first flow path in which a heated flowstream can flow, a second flow path in which an unheated flowstream can flow, and an exit plane at which each of the first flow path and the second flow path terminate, wherein the exit plane defines a first side on which traverse the first flow path and the second flow path and a second side on which a target can reside, and wherein the first flow path and the second flow path are configured so that the heated flowstream is separate from and does not mix with the unheated flowstream on the first side.

In another embodiment, a drying apparatus is disclosed, comprising a plenum configured to direct an inlet flowstream as a heated flowstream and an unheated flowstream to an exit plane, the exit plane defining a first side on which the heated flowstream is separate from and does not mix with the unheated flowstream and a second side on which a target can reside.

In yet another embodiment, a plenum assembly is disclosed, comprising a outer plenum member having an inner cavity that terminates at an outer bottom wall, and an inner plenum member disposed in the inner cavity, wherein the outer plenum member and the inner plenum member are configured to direct a heated flowstream and an unheated flowstream to traverse the inner cavity to the outer bottom wall, and wherein the heated flowstream and the unheated flowstream are kept separate and do not mix in the inner cavity.

### BRIEF DESCRIPTION OF THE DRAWINGS

For further understanding of the subject matter, reference is will be made to the following detailed description, which is to be read in connection with the accompanying drawings, in which:

FIG. 1 is a perspective view of an exemplary embodiment of a drying apparatus;

FIG. 2 is a schematic diagram of another exemplary embodiment of a drying apparatus;

FIG. 3 is a schematic diagram of yet another exemplary embodiment of a drying apparatus;

FIG. 4 is an assembly, perspective view of still yet another exemplary embodiment of a drying apparatus;

FIG. 5 is an exploded, assembly, perspective view of the drying apparatus of FIG. 4;

FIG. 6 is an assembly, perspective view of a plenum assembly of the drying apparatus in FIG. 5;

FIG. 7 is a side, cross-section view of the plenum assembly of FIG. 6;

FIG. 8 is a top view of the plenum assembly of FIG. 6;

FIG. 9 is a top view of an example of a lower plenum member for use in the plenum assembly of FIGS. 6-8;

FIG. 10 is a top view of an example of a heater housing for use in the plenum assembly of FIGS. 6-8; and

FIG. 11 is a perspective, assembly view of an example of a heater element for use in the plenum assembly of FIGS. 6-8.

Where applicable like reference characters designate identical or corresponding components and units throughout the several views, which are not to scale unless otherwise indicated.

### DETAILED DESCRIPTION

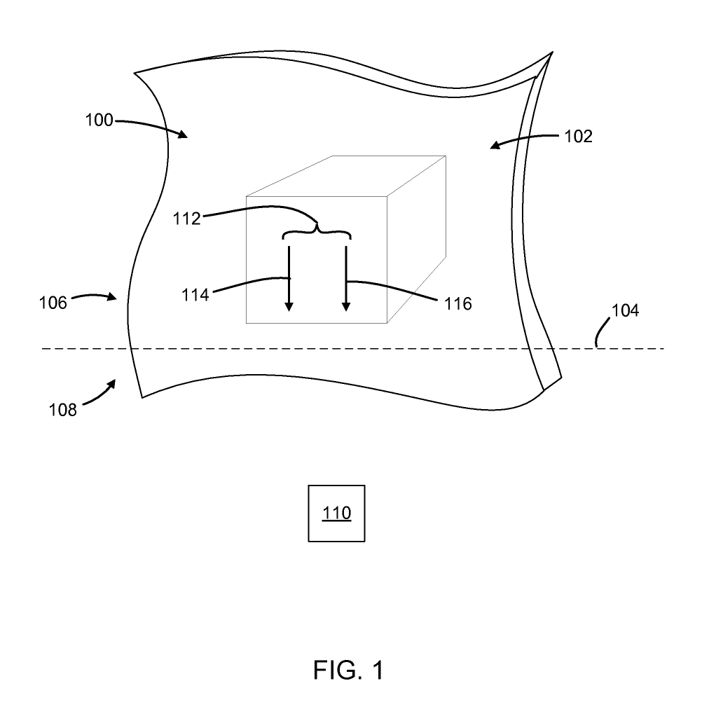

FIG. 1 depicts at a high level and in general configuration an exemplary embodiment of an apparatus 100 (or, “drying apparatus 100”). The drying apparatus 100 can mount to a wall 102, such as in a wash room, lavatory, or proximate an area where an end user may, e.g., wash and dry their hands. The drying apparatus 100 expels air across an exit plane 104 and, in one example, the air traverses the exit plane 104 from a first side 106 to a second side 108 where a target 110 resides. In one embodiment, air flows in a plurality of flowstreams 112 that include a heated flowstream 114 and an unheated flowstream 116, both of which form on the first side 106 and remain separated from and do not mix with one another on the first side 106 up to the exit plane 104 or, in one example, until the flowstreams 112 cross the exit plane 104.

The first side 106 may comprise the interior of the drying apparatus 100. In the interior, for example, the drying apparatus 100 may include a plenum, chamber, or other elements (or groups of elements) that divert an inlet flowstream to form the heated flowstream 114 and the unheated flowstream 116. The inlet flowstream may arise from an air moving device such as a fan unit, which causes air to traverse the drying apparatus 100. Flow rates for the inlet flowstream can be about 15 l/s to about 100 l/s, however, the flow rate can vary in accordance with the implementation of the drying apparatus 100. For example, although the present discussion focuses on hand dryers, the drying apparatus 100 can also embody various consumer products such as hair dryers and commercial drying products for use in, e.g., industrial and/or factory settings.

The second side 108 generally includes areas exterior to the drying apparatus 100. In one embodiment, the second side 108 may include areas inside of the drying apparatus 100, such as if the exit plane 104 is coplanar with a plane (e.g., a bottom plane) of an outer housing and/or a nozzle that directs the heated flowstream 114 and the unheated flowstream 116 from the drying apparatus 100. Nozzles of the type for use with the drying apparatus 100 may permit the end user to change the trajectory of the flowstreams 112. For example, the end user may articulate the nozzle to direct air from a first trajectory for drying the hands to a second trajectory for drying the face.

The drying apparatus 100 may deploy one or more heating devices (not shown) that actively heat the air of the heated flowstream 114. Exemplary heating devices cause the heated flowstream 114 to reach at least about 55° C. and, in a more particular example, the heated flowstream 114 enters the second side 108 at about 55° C. to about 70° C. On the other hand, the drying apparatus 100 does not actively heat the air of the unheated flowstream 116. When the unheated flowstream 116 is kept separate from heated flowstream 114, the unheated flowstream 116 enters the second side 108 at or about 37° C. and/or generally within about 15° C. of the temperature of the inlet flowstream mentioned above.

In one implementation, the temperature of the heated flowstream 114 creates a sensation of warmth and comfort for the end user. The inventors note, for example, that the contiguous surface area of the palm or back of the hands can benefit from contact with the heated flowstream 114. On the other hand, contact with the heated flowstream 114 on portions of the end user's hand such as the fingers, where the surface area is smaller and/or less sensitive relative to the palm, may not be as effective to create the desired sensation. Thus, embodiments of the drying apparatus 100 can direct each of the heated flowstream 114 and the unheated flowstream 116 onto areas where the end user is to benefit from the desired sensation of warmth and comfort.

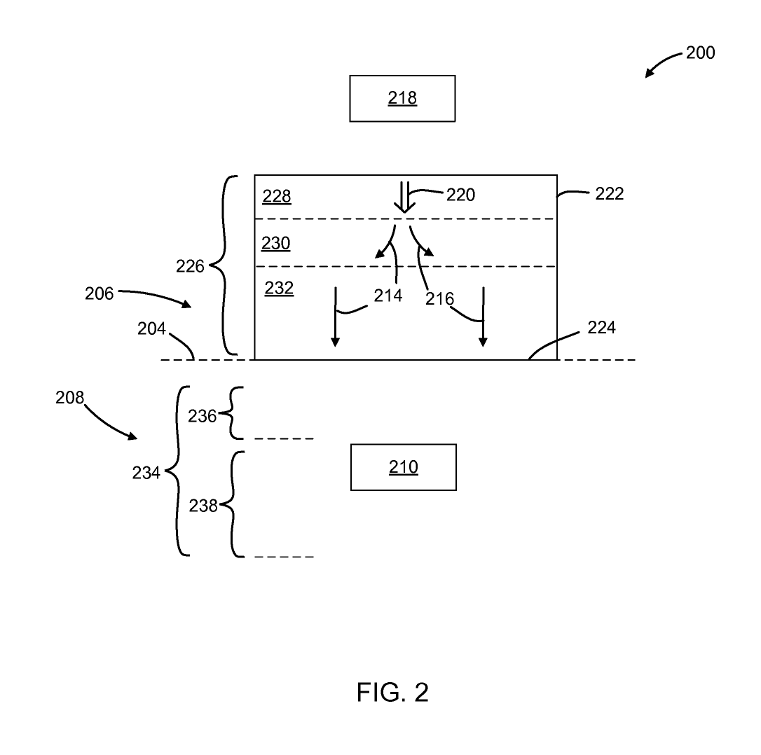

Referring next to FIG. 2, a schematic diagram of another exemplary embodiment of an apparatus 200 (or “drying apparatus 200”) is shown. Like numerals are used to identify like components as between FIG. 1 and FIG. 2, but the numerals are increased by 100. For example, the drying apparatus 200 has an exit plane 204, which defines a first side 206 and a second side 208, and generates a heated flowstream 214 and an unheated flowstream 216. The drying apparatus 200 also comprises an air moving device 218 that delivers an inlet flowstream 220 into a plenum 222. The plenum 222 has a bottom plane 224, which in one example is coplanar with the exit plane 204, and a plurality of interior flow regions 226. The discussion below uses the interior flow regions 226 to describe changes in the air flow that occur as the inlet flowstream 220 traverses the plenum 222. The interior flow regions 226 include an inlet flow region 228, a flow transition region 230, and a separated flow region 232 that terminates at the exit plane 204. Also shown in FIG. 2 are exterior flow regions 234, which are below the exit plane 204. The exterior flow regions 234 include an initial mixing region 236 and an impingement region 238.

The inlet flowstream 220 may enter the plenum 222 in the inlet flow region 228. The inlet flowstream 220 is generally unheated, having properties (e.g., temperature and flow rate) consistent with properties the air moving device 218 generates in air. In the flow transition region 230, the inlet flowstream 220 may separate into one or more of the heated flowstream 214 and the unheated flowstream 216. The inlet flowstream 220 may be in the form of a single inlet flowstream or multiple inlet flowstreams that originate from one or more sources, including an air moving device. Configurations of the plenum 222 can facilitate this separation, such as by directing portions of the inlet flowstream 220 to different locations of the plenum 222, in different directions within the plenum 222, and the like. The inventors contemplate, for example, that the plenum 222 can comprise elements such as baffles, tubes, fins, and conduits that can divert the inlet flowstream 220. In the present example, the inlet flowstream 220 develops into the heated flowstream 214 and the unheated flowstream 216, although other embodiments lend themselves to the formation of additional flowstreams as desired.

The heated flowstream 214 and the unheated flowstream 216 individually traverse the separated flow region 232 to the exit plane 204. In one embodiment, the heated flowstream 214 flows contiguously with the unheated flowstream 216 across the exit plane 204. That is, the drying apparatus 200 can expel the heated flowstream 214 and the unheated flowstream 216 into the initial mixing region 236 independently of one another. Each of the heated flowstream 214 and the unheated flowstream 216 may traverse the initial mixing region 236 to the impingement region 238 without substantial mixing. However, some mixing in the initial mixing region 236 may occur due to turbulent flow dynamics, proximity of the heated flowstream 214 and the unheated flowstream 216, flow direction, and other conditions prevalent in the initial mixing region 236.

The heated flowstream 214 and the unheated flowstream 216 impinge on the target in the impingement region 238. Contact with the target may induce turbulent mixing and other fluid dynamic phenomenon. As discussed above, configurations of the plenum 222 prevent mixing of the heated flowstream 214 and the unheated flowstream 216 on the first side 206 of the exit plane 204. When the drying apparatus 100 acts as a hand dryer, the inventors have found that the separation of the flowstreams (e.g., the heated flowstream 214 and the unheated flowstream 216) permits the drying apparatus 200 to heat the air of the heated flowstream 214 to higher temperatures but at a lower expenditure of energy because, in one example, the volume of air in the heated flowstream 214 is less than might be heated in conventional hand dryer technology. These higher temperatures are effectively offset by the relatively cooler temperatures of the unheated flowstream 216, which the drying apparatus 200 does not actively heat, and which the drying apparatus 200 causes to impinge on the target at substantially the same time and in substantially the same general area as the heated flowstream 214. The heated flowstream 214 impinges on the target 210, which causes the sensation of warmth and comfort discussed above, and mixes (e.g., turbulently) with the unheated flowstream 216. As the flowstreams (e.g., the heated flowstream 214 and the unheated flowstream 216) impinge and mix, evaporative drying takes place due, in one example, to the flow rate (and elevated temperature) of the heated flowstream 214 and the flow rate of the unheated flowstream 216.

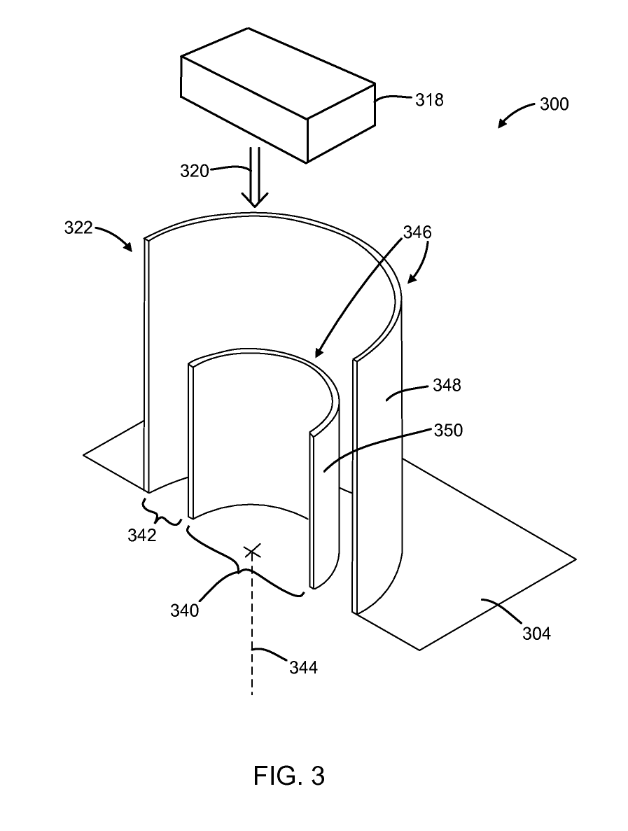

FIG. 3 illustrates another exemplary embodiment of an apparatus 300 (or “drying apparatus 300”), which has an exit plane 304 that defines a first side 306 and a second side 308. FIG. 3 also shows an air moving device 318 that delivers an inlet flow 320 into a plenum 322. The plenum 322 has a first flow path 340 and a second flow path 342 through which the drying apparatus 300 can deliver the heated flowstream and the unheated flowstream discussed above. In one embodiment, the plenum 322 has a central axis 344 and comprises one or more plenum members 346 such as an outer plenum member 348 and an inner plenum member 350.

The plenum members 346 can comprise elongated, cylindrical members that align coaxially on a common axis (e.g., the central axis 344). However, other constructions can have various other form factors that form the first flow path 340 and the second flow path 342 through which air traverse on the first side 306. Other arrangements of the plenum members 346 may direct air in directions and orientations about the drying apparatus 300 that are non-concentric or eccentric with respect to the plenum 322 as well as with respect to each other.

In one embodiment, the drying apparatus 300 induces active heating in only one of the first flow path 340 and the second flow path 342. This configuration can cause the heated flowstream to traverse the first flow path 340 and the unheated flowstream to traverse the second flow path 342, and vice versa. When flow paths in addition to the first flow path 340 and the second flow path 342 are present, individual ones of these flow paths may be designated for the heated flowstream and equipped to induce active heating, while other flow paths are designated for the unheated flowstream.

To facilitate active heating, the drying apparatus 300 may include a heating element (not shown) that permits the transfer of thermal energy to the air in the flow paths designated for the heated flowstream. The heating element can change the temperature of air and, more particularly, to raise the temperature of air that traverses the flow path(s) designated for the heated flowstream. The heating element may be a stand-alone unit that is disposed in the flow path designated for the heated flowstream. Other configurations of the drying apparatus 300 may incorporate the heating element as part of the structure of one or more of the plenum members 346. Exemplary heating elements can include resistive heaters that generate heat in response to electrical stimulation.

Generally the plenum members 346 effectively prevent air in the first flow path 340 from mixing with air in the second flow path 342 on the first side 306. In one example, mixing does not occur on the first side 306. In another example, the air in the first flow path 340 is kept separate from the air in the second flow path 342 until the air traverses the exit plane 304 from the first side 306 to the second side 308. In yet another example, mixing only occurs after the air in each of the first flow path 340 and the second flow path 342 enters the second side 308.

The plenum members 346 lend themselves to construction using metals, plastics, and other materials. Other materials that prevent and/or dissipate the transfer of thermal energy may also be used. Insulation can be incorporated as part of the plenum members 346 or, in one example, as separate layers and elements that separate and insulate the flow paths. Costs and pricing may influence the selection of materials and fabrication techniques. Manufacturing can occur by way of molding, extruding, and the like. These techniques are useful to form many of the components of the drying apparatus 300 monolithically such as by forming one or more of the plenum members 346 as a single, unitary structure. In other embodiments, construction takes the form of separate pieces and sub-assemblies, and fasteners and adhesives secure the construction as those artisans skilled in the commercial product arts will recognize.

The air moving device 318 can include elements such as fans and impellers that can induce movement of air. Suitable elements may operate at a single speed where the element can be placed in an active or ON state and an inactive or OFF state. Other elements may operate at a selection of pre-defined speeds (e.g., a high speed and a low speed) or at variable speeds. In one embodiment, selection of the speed and/or state occurs in response to control signals from a control device (not shown). Moreover, these elements are sized and configured to move air with properties (e.g., the flow rate) consistent with the properties discussed herein. These elements may also be sized to fit within the plenum 322 and/or may be located remote from the drying apparatus 300 as desired. For remote configurations, air from the air moving device 318 can be directed to the general location of the plenum 322.

The amount of flow desired for each of the heated flowstream and the unheated flowstream can also define the design, layout, and arrangement of elements in the drying apparatus 300. For example, the number of flow paths can vary as a function of the ratio of the volume of heated air (e.g., the volume of the heated flowstream) to the volume of unheated air (e.g., the volume of the unheated flowstream). This ratio may consider the percentage for each of the heated air and the unheated air that the drying apparatus delivers onto the skin surface to create the sensation of warmth and comfort. This sensation, which was discussed above, can depend on a number of factors including air velocity at the target, the properties of the ambient, air (e.g., temperature and humidity), as well as variations in the target (e.g., the physical anthropometry of the body part) on which the heated air impinges. At a relatively high level, the inventors quantify exemplary values for the ratio of the percent volume of the heated flowstream to the percent volume of the unheated flowstream in the range of about 0.3:1 to about 0.5:1. In one example, the ratio is about 0.5:1.

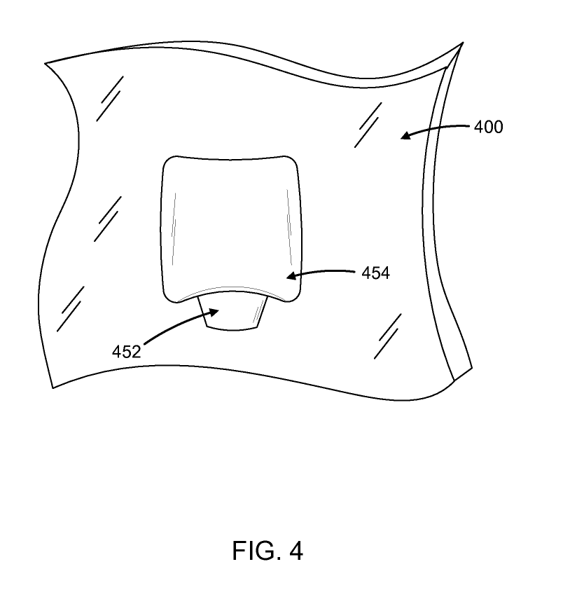

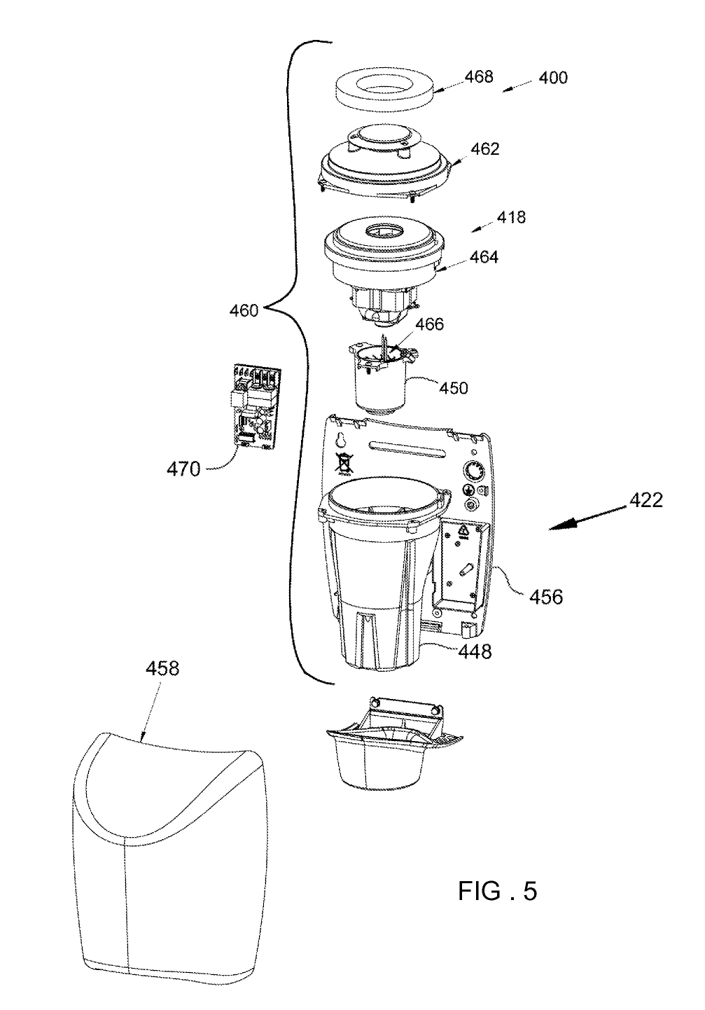

The remaining FIGS. 4-11 depict in various illustrations another exemplary embodiment of an apparatus 400 (or “drying apparatus 400”). The assembly view of FIG. 4 shows the drying apparatus 400 with a nozzle 452 and a cover assembly 454. As best shown in FIG. 5, the drying apparatus 400 comprises an air moving device 418 and a plenum 422 having an outer plenum member 448 and an inner plenum member 450. The cover assembly 454 can comprise a mounting plate 456 and a bezel 458, which fits over and encloses the components of the drying apparatus 400. The drying apparatus 400 can have a plenum assembly 460 that includes the outer plenum member 448 and the inner plenum member 450, as well as a plenum cap 462, a fan unit 464, and a heating element 466.

In one embodiment, the drying apparatus 400 also has an air filter 468 such as a HEPA filter and a control device 470. The control device 470 can effectuate operation of, e.g., the fan unit 464 and the heater element 466. At a relatively high level, the control device 470 can receive inputs and generate control signals in response to the inputs. The control signals can cause certain operation of the drying apparatus 400 such as activation of the fan unit 464, changes in speed of the fan unit 464, and activation and temperature control of the heater element 466. Inputs can arise from sensors (e.g., motion sensors) and switches (e.g., push buttons and/or toggles). In response to the input, the control device 470 may generate a first control signal that, for example, may activate the fan unit 464. Exemplary circuits and elements for use in the control device 470 may include, but are not limited to, discrete elements such as resistors, transistors, diodes, switches, and capacitors, as well as microprocessors and other logic devices such as field programmable gate arrays (“FPGAs”) and application specific integrated circuits (“ASICs”).

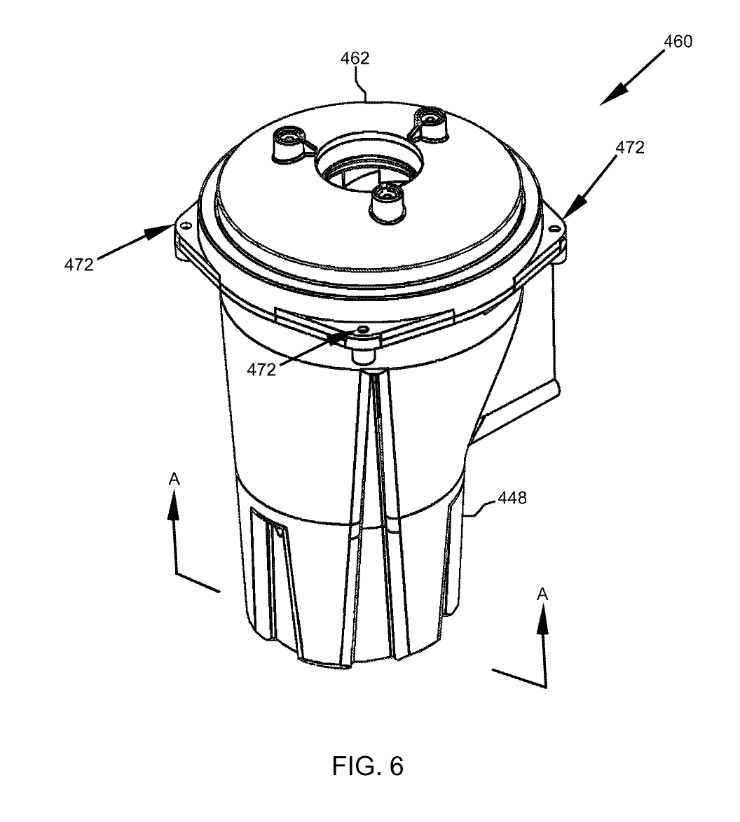

FIGS. 6-8 focus on an exemplary assembly of the plenum assembly 460. In FIG. 6, the plenum assembly 460 can comprise one or more cap fastening features 472 that secure the plenum cap 462 to the outer plenum member 448. The cap fastening features 472 can include threaded and tapped bosses, through holes, threaded inserts, and the like. The inventors also contemplate configurations in which adhesive and/or weld permanently secures the plenum cap 462 and the outer plenum member 448. In one embodiment, the preferred fastening means permits the plenum cap 462 to be displaced and reaffixed from the outer plenum member 448. This feature provides access to the components located in the interior of the plenum assembly 460. Suitable fasteners include screws, nuts, and bolts of any number of sizes, varieties, and combinations. The plenum assembly 460 also lends itself to other fastening means such as, but not limited to, clasps, hasps, hinges, and like arrangements of elements that secure the plenum cap 462 to the outer plenum member 448.

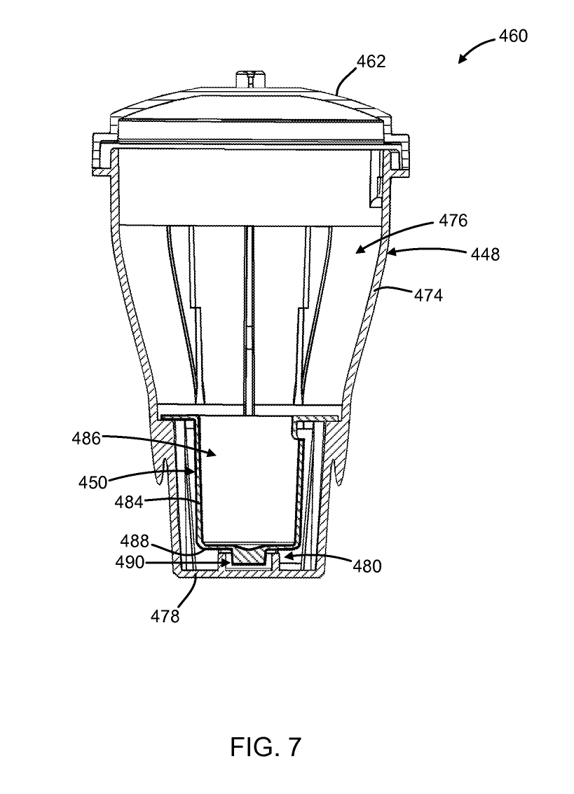

FIG. 7 depicts a section view of the plenum assembly 460 taken along line A-A (FIG. 6). The inventors note that, for reasons of clarity, components such as the fan unit 464 and the heating element 466 are hidden from view in FIG. 7. In the present example, the plenum assembly 460 is shown with the outer plenum member 448, the inner plenum member 450, and the plenum cap 462. Any of the components that the present disclosure discusses, however, are compatible with the arrangement of elements in FIG. 7. In one embodiment, the outer plenum member 448 comprises an outer peripheral wall 474 that bounds an inner cavity 476 and an outer bottom wall 478 with a first mating feature 480. The inner plenum member 450 comprises an inner peripheral wall 484 forming a hollow interior 486 and an inner bottom wall 488 with a second mating feature 490 extending therefrom.

The inner cavity 476 can have varying internal dimensions. Values for the internal dimensions permit the inner cavity 476 to receive one or more of the components of the plenum assembly 460 therein. In one embodiment, the inner cavity receives the inner plenum member 450 in a manner that aligns the first mating feature 480 and the second mating feature 490. Preferably a portion of the second mating feature 490 fits and extends into the first mating feature 480. The relationship between these features permits air to pass from, e.g., the fan unit (not shown), into and through the hollow interior 486 and through apertures (not shown) in the outer bottom wall 478 and the inner bottom wall 488. In one example, the first mating feature 480 and the second mating feature 490 overlap and/or engage one another. This configuration prevents air that traverses the hollow interior 486 to mix with air that travels about other parts of the plenum assembly 460, e.g., outside of the inner plenum member 450.

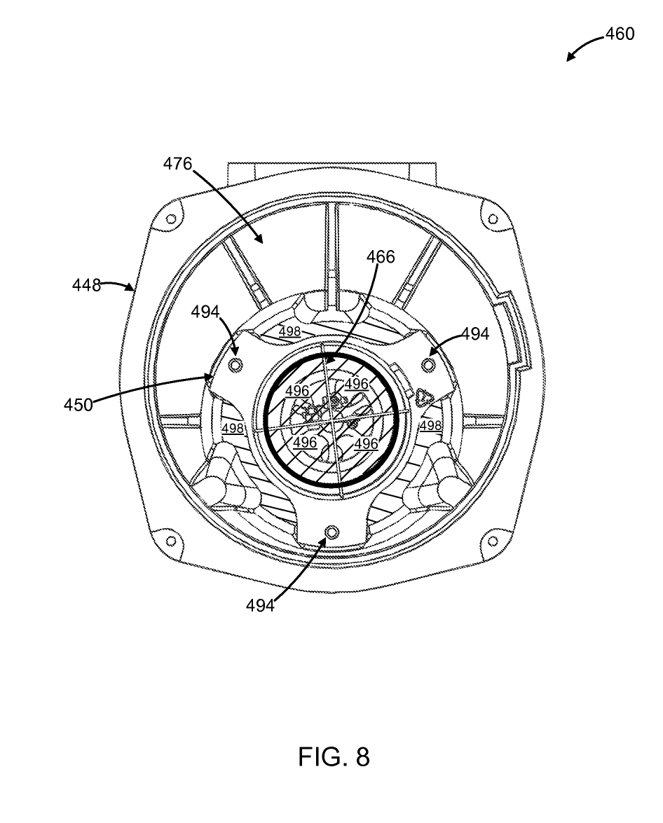

FIG. 8 illustrates a top view of the plenum assembly 460 of FIG. 6 with the plenum cap 462 and the fan unit 464 removed. FIG. 8 reveals the inner cavity 476 of the outer plenum member 448 with the inner plenum member 450 and the heating element 466 disposed therein. Each of the outer plenum member 448 and the inner plenum member 450 can comprise one or more interior fastening areas 494 that can position and secure the inner plenum member 450 in the inner cavity 476. Suitable fasteners include screws and bolts and other implements discussed in connection with the cap fastening features 472. The configuration of the outer plenum member 448 and the inner plenum member 450 creates a first flow path 496 and a second flow path 498. Particular to this configuration, the heated flowstream traverses the first flow path 496 and the unheated flowstream traverses the second flow path 498.

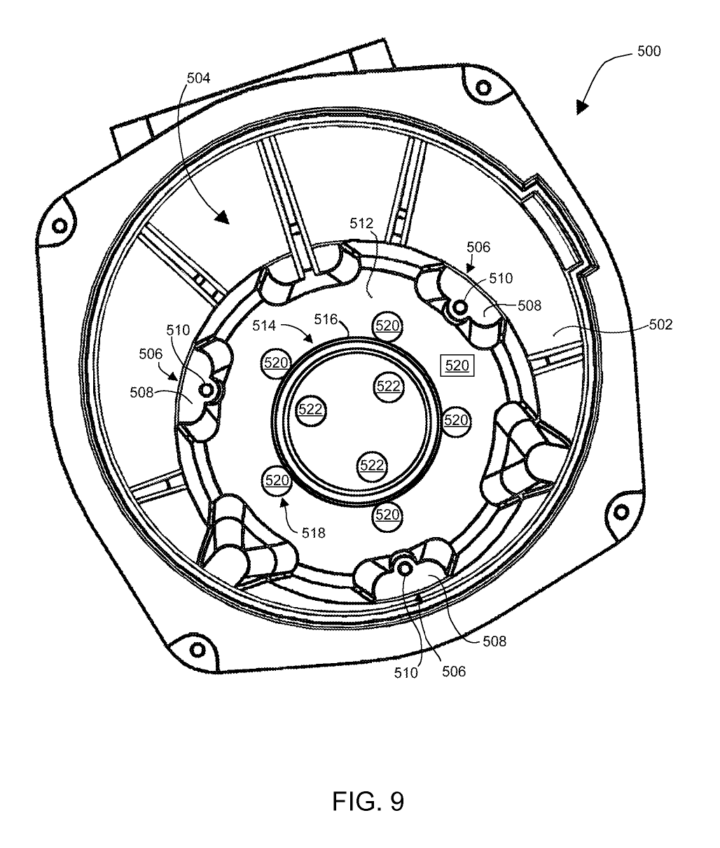

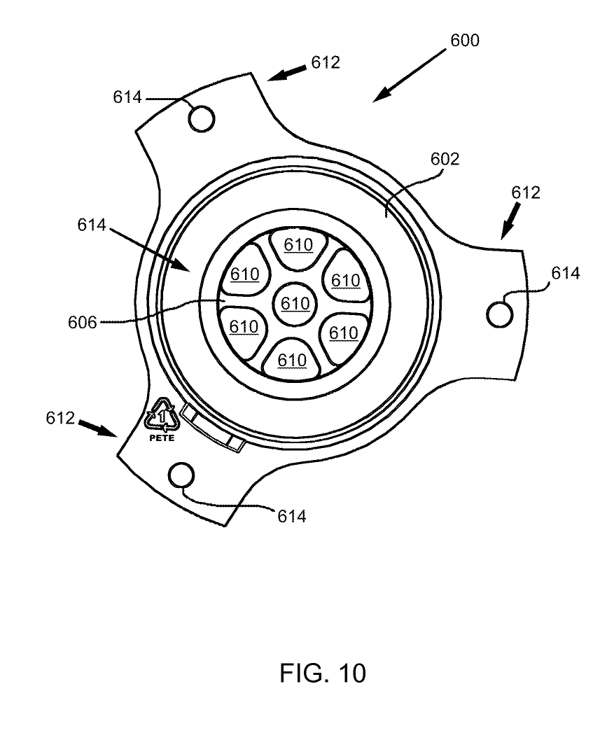

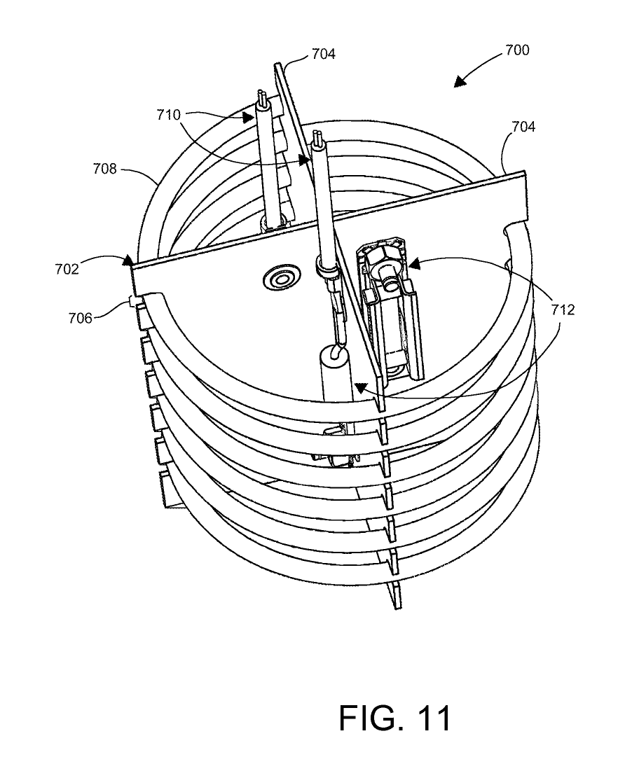

FIGS. 9-11 focus on components found in, e.g., the plenum assembly 460, namely, exemplary configurations of an outer plenum member 500 (FIG. 9), an inner plenum member 600 (FIG. 10), and a heating element 700 (FIG. 11).

FIG. 9 depicts a top view of an example of an outer plenum member 500. The outer plenum member 500 can comprise an outer peripheral wall 502 that forms an inner cavity 504. The outer plenum member 500 also has a plurality of support features 506 that each have a fastening area 508 such as a threaded hole 510. An outer bottom wall 512 provides a lower boundary for the inner cavity 504. The outer bottom wall 512 can comprise a first mating feature 514 in the form of an annular protrusion 516 extending into the inner cavity 504. The outer bottom wall 512 also comprises a plurality of apertures 518 arranged as a first set 520 and a second set 522 separated from the first set 520 by the annular protrusion 516.

FIG. 10 illustrates a top view of an example of an inner plenum member 600. The inner plenum member 600 can comprise an inner peripheral wall 602 that forms a hollow interior, which terminates at an inner bottom wall 606. One or more apertures 610 extend through the inner bottom wall 606. The inner plenum member 600 also includes a plurality of mounting features 612 with mounting holes 614. The mounting features 612 extend from the inner peripheral wall 602 and are displaced annularly from one another about the periphery of the inner peripheral wall 602.

With continued reference to FIGS. 9 and 10, each of the outer plenum member 500 and the inner plenum member 600 are amenable to construction using the materials discussed above. Cost considerations may benefit from molding and/or extruding, although more robust designs and/or specific applications may require other techniques and materials. When assembled as part of a plenum assembly (e.g., the plenum assembly 460), the outer plenum member 500 receives the inner plenum member 600 in the inner cavity 504. The inner plenum member 600 rests on the support features 506 and, in one example, the mounting features 612 mate with the support features 506 to substantially align the mounting holes 614 with the threaded hole 510. Fasteners can secure the inner plenum member 600 to the outer plenum member 500.

The inventors note that, in one example, assembly of the inner plenum member 600 in the outer plenum member 500 places the apertures 610 in flow connection the second set 522. Flow connection of these apertures permits air that traverses the hollow interior of the inner plenum member 600 to exhaust through each of the inner bottom wall 606 and the outer bottom wall 512. When the heating element resides in the hollow interior of the inner plenum member 600, this feature facilitates expulsion of the heated flowstream, as the present disclosure describes in detail above.

FIG. 11 depicts an example of a heater element 700. The heater element 700 comprises an insulator element 702, in this case a pair of insulator plates 704 with support features 706 that receive a wire coil 708 therein. The heater element 700 can also comprise a pair of leads 710 and one or more temperature regulators 712.

The heater element 700 may be rated for about 300 Watts to about 600 Watts of input power and generate heating profiles with characteristics suitable to achieve the performance designated above. The heating element may be separately embodied, as illustrated in FIG. 11, and disposed in and/or proximate the designated flow path for the heated flowstream to cause heating to take place. In the present example, the heater element 700 can reside in the inner plenum member (e.g., the inner plenum member 600). However, other examples of the heating element can be integrated into the structure of, e.g., the outer plenum member 500. For example, the heating element can be incorporated as part of the wall of one or more of the outer plenum member and the inner plenum member.

In view of the foregoing, the discussion above describes various configurations of an apparatus that can generate multiple flowstreams, including a heated flowstream and an unheated flowstream. The apparatus maintains the heated flowstream and the unheated flowstream as separate, directing each flowstream to an exit plane and preventing mixing of the flowstreams until, in one example, the flowstreams reach and/or traverse the exit plane. Embodiments of this apparatus expend less energy because the apparatus does not heat all of the flowstreams that the apparatus expels, but rather can heat certain ones (e.g., the heated flowstream) to higher temperatures.

Where applicable, it is contemplated that numerical values, as well as other values that are recited herein are modified by the term “about”, whether expressly stated or inherently derived by the discussion of the present disclosure. As used herein, the term “about” defines the numerical boundaries of the modified values so as to include, but not be limited to, tolerances and values up to, and including the numerical value so modified. That is, numerical values can include the actual value that is expressly stated, as well as other values that are, or can be, the decimal, fractional, or other multiple of the actual value indicated, and/or described in the disclosure.

This written description uses examples to disclose embodiments of the invention, including the best mode, and also to enable any person skilled in the art to practice the invention, including making and using any devices or systems and performing any incorporated methods. The patentable scope of the invention is defied by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An apparatus, comprising:
a first flow path in which a heated flowstream can flow;
a second flow path in which an unheated flowstream can flow; and
an exit plane at which each of the first flow path and the second flow path terminate,
wherein the exit plane defines a first side on which traverse the first flow path and the second flow path and a second side on which a target can reside, and
wherein the first flow path and the second flow path are configured so that the heated flowstream is separate from and does not mix with the unheated flowstream on the first side.

2. An apparatus according to claim 1, wherein the second flow path is located peripherally about the first flow path.

3. An apparatus according to claim 1, wherein the first flow path is located peripherally about the second flow path.

4. An apparatus according to claim 1, wherein the first flow path is aligned concentrically with the second flow path.

5. An apparatus according to claim 1, wherein the heated flowstream and the unheated flowstream are formed from a single inlet flowstream.

6. An apparatus according to claim 1, further comprising a housing enclosing the first flow path and the second flow path, the housing have a bottom plane that is coplanar with the exit plane.

7. An apparatus according to claim 1, further comprising a plenum that defines each of the first flow path and the second flow path, the plenum having a bottom plane that is coplanar with the exit plane.

8. An apparatus according to claim 1, further comprising:
a plenum that defines each of the first flow path and the second flow path; and
a housing enclosing the plenum,
wherein the exit plane is coplanar with a bottom plane of one of the housing and the plenum.

9. A drying apparatus, comprising:
a plenum configured to direct an inlet flowstream as a heated flowstream and an unheated flowstream to an exit plane, the exit plane defining a first side on which the heated flowstream is separate from and does not mix with the unheated flowstream and a second side on which a target can reside.

10. A drying apparatus according to claim 9, further comprising a fan unit that is enclosed in the plenum, wherein the fan unit generates the inlet flowstream, and wherein the plenum is configured to separate the inlet flowstream into the heated flowstream and the unheated flowstream.

11. A drying apparatus according to claim 10, further comprising a cover assembly having a mounting plate and a bezel enclosing the fan unit and the plenum therein.

12. A drying apparatus according to claim 9, further comprising a nozzle, wherein the nozzle is in flow connection with each of the heated flowstream and the unheated flowstream.

13. A drying apparatus according to claim 9, wherein the plenum is configured so the heated flowstream and the unheated flowstream traverse the exit plane independently of one another.

14. A drying apparatus according to claim 9, wherein the plenum is configured to transfer thermal energy to the inlet flowstream to create the heated flowstream.

15. A drying apparatus according to claim 9, further comprising a first flow path and a second flow path, each disposed in the plenum and terminating at the exit plane, wherein one of the first flow path and the second flow path are configured to transfer thermal energy to the inlet flowstream.

16. A plenum assembly, comprising:
a outer plenum member having an inner cavity that terminates at an outer bottom wall; and
an inner plenum member disposed in the inner cavity,
wherein the outer plenum member and the inner plenum member are configured to direct a heated flowstream and an unheated flowstream to traverse the inner cavity to the outer bottom wall, and
wherein the heated flowstream and the unheated flowstream are kept separate and do not mix in the inner cavity.

17. A plenum assembly according to claim 16, wherein the outer bottom wall comprises apertures in flow connection with each of the heated flowstream and the unheated flowstream.

18. A plenum assembly according to claim 16, further comprising a fan unit and a heater element, each disposed in the inner cavity, wherein the fan unit generates an inlet flowstream, and wherein the outer plenum member and the inner plenum member are configured to direct the inlet flowstream in thermal contact with the heater element to generate the heated flowstream.

19. A plenum assembly according to claim 16, further comprising a first flow path and a second flow path, wherein one of the first flow path and the second flow path is formed by a surface of the inner plenum member and a surface of the inner cavity.

20. A plenum assembly according to claim 16, wherein the outer plenum member and the inner plenum member are aligned on a common axis.
